(19) United States
(12) Patent Application Publication
(10) Pub. No.: US 2026/0192530 A1
(43) Pub. Date: Jul. 9, 2026

(54) PROCESS FOR PRODUCING A PLASTICS COMPONENT

(71) Applicant: BASF SE, Ludwigshafen am Rhein (DE)

(72) Inventor: Andreas WUEST, Ludwigshafen am Rhein (DE)

(21) Appl. No.: 19/132,924

(22) PCT Filed: Nov. 27, 2023
(86) PCT No.: PCT/EP2023/083122

§ 371 Date: May 27, 2025

(30) Foreign Application Priority Data
Nov. 28, 2022 (EP) 22209860.0

(51) Int. Cl. B29C 70/68; B29C 33/12; B29C 70/70; B29C 70/74; B29K 23/00; B29K 77/00; B29K 105/00; B29K 105/04; B29K 105/20; B29K 623/00; B29K 677/00; B29K 705/00; B29K 709/02

(52) U.S. Cl. CPC B29C 70/682; B29C 33/12; B29C 70/70; B29C 70/745; B29K 2023/06; B29K 2023/12; B29K 2077/00; B29K 2105/0067; B29K 2105/04; B29K 2105/20; B29K 2623/06; B29K 2623/12; B29K 2677/00; B29K 2705/00; B29K 2709/02

(57) ABSTRACT

The invention relates to a process for producing a plastics component (1) comprising an insert (13) which is enclosed by a hollow body (11), the process comprising:
(a) placing the insert (13) into a mold such that a gap is formed between the insert (13) and the mold;
(b) feeding a polymer melt into the gap thereby forming the hollow body (11) enclosing the insert (13);
(c) removing the plastics component (1) from the mold;
wherein for forming the gap elevations (17) are formed on the insert (13), or wherein the mold comprises pins (25) on which the insert is placed, or wherein the gap is a recess in the insert (13).

The invention relates to a process for producing a plastics component comprising an insert which is enclosed by a hollow body, the process comprising:
(a) placing the insert into a mold such that a gap is formed between the insert and the mold;
(b) feeding a polymer melt into the gap thereby forming the hollow body enclosing the insert;
(c) removing the plastics component from the mold.

Plastic components which are produced by injection molding have to be adapted to the lim-its and boundary conditions given by the injection molding process and must be accordingly designed. Limitations of an injection molding process usually are due to mass accumulations and to the demolding of the injection molded plastics component by opening the mold.

Mass accumulations usually result in higher cycle times, because the plastics component needs longer cooling times. Further, mass accumulations also increase the risk for buildup of internal voids. For this reasons, the plastics components produced by injection molding processes should have a small wall thickness.

For demolding the plastics component, it is necessary, that each internal core, insert or geometric design, which reduces the mass accumulations must have a shape which allows opening the mold and withdraw the plastics component. This leads to constraints in the geometry of the plastics component and requires molds with complex moveable cores and complex kinematics for opening and closing.

Presently, there are several non-standard injection molding processes by which hollow parts can be produced to avoid such mass accumulations. Such non-standard injection molding processes are for example Gas-Assisted Injection Molding (GAIM) or Water-Assisted Injection Molding Technology (WIT) or fusible core technology.

In GAIM/WIT the mold is completely filled with the polymer melt and subsequently a part of the hot polymer melt is pushed out of the mold by injecting a liquid, usually water, or a gas. By this injection of liquid or gas the polymer melt contacting the walls of the mold remains in the mold and a hollow part is formed. In fusible core technology, a metal core is inserted in the mold which afterwards has to be melted out for creating the hollow section.

GAIM/WIT processes have the disadvantage that a complex injection machine is necessary for injecting the liquid or gas and further, due to the high pressure and velocity of the liquid or gas, the wall thickness of the hollow part or the plastics component may be uneven. In fusible core technology, the removal of the metal core results in additional process steps.

Therefore, it is an object of the present invention to provide a process for producing plastics components without mass accumulations and which does not have the disadvantages of the known GAIM/WIT processes or the fusible core technology.

This object is achieved by a process for producing a plastics component comprising an insert which is enclosed by a hollow body, the process comprising:
(a) placing the insert into a mold such that a gap is formed between the insert and the mold;
(b) feeding a polymer melt into the gap thereby forming the hollow body enclosing the insert;
(c) removing the plastics component from the mold, wherein for forming the gap elevations are formed on the insert, or wherein the mold comprises pins on which the insert is placed, or wherein the gap is a recess in the insert.

By using the insert and keeping the insert in the plastics component, a plastics component comprising sections with different wall thicknesses can be produced without the disadvantages of the known processes. Particularly if an insert is used with a low weight, a plastics component can be produced which has a lower weight than a plastics component with walls made of solid material. Further, if the gap is a recess in the insert, it is possible to locate the distribution point of the polymer melt to a position which cannot be realized with the injection point in the mold, for example on the underside of the insert, and by which a balanced fill and an undisturbed fiber-orientation for making use of anisotropic material behavior and a reduced warpage of the plastics component can be achieved.

Further, by forming the gap by using elevations formed on the insert or pins in the mold onto which the insert is placed or the gap being a recess in the insert, the insert forms a part of the mold. For this reason, the walls of the plastics component which form the hollow body have a defined thickness and shape in difference to the walls produced by the known GAIM/WIT processes. In difference to the fusible core technology the insert remains in the plastics component and is not melted out, so that the process is much simpler. For producing the plastics component by the inventive process, a standard injection molding process can be used, which also simplifies the process for producing the plastics component. Other liquid plastics molding processes, e.g. casting processes (e.g. RIM) are also suitable.

For producing a lightweight component, it is preferred to use an insert which is made of a foam and/or which is a second hollow body. Particularly, the insert is made of a foam. Due to the gas forming the bubbles of the foam, the foam has a much lower density than a solid insert, so that a component can be produced which has a lower weight than a comparable component with solid walls.

As the insert forms a part of the mold during feeding the polymer melt, it is necessary to use a material or a construction of the insert which is able to withstand the loads and tempera-tures during feeding the polymer melt.

If the insert is a second hollow body, it is preferred to produce at least two parts of the second hollow body and to connect the parts afterward for forming the second hollow body. The connection may be realized by welding, soldering or gluing. Alternatively, it is also possible to only place the parts together without any fixation, because the parts are fixed in the mold by the elevations or the pins and after being surrounded by the polymer melt from the polymer forming the hollow body. However, for avoiding a displacement of the parts, it is preferred to provide grooves and tongues or recesses on the edges which are in contact when the parts are connected. If the second hollow body is formed by connecting at least two parts, it is particularly advantageous that the parts can be produced by standard processes, for example by standard injection molding.

Depending on the size of the insert and the pressure which acts on the insert, it may be necessary to reinforce the insert, if it is a second hollow body. For reinforcing the second hollow body, it for example may comprise columns or walls connecting opposite inner walls of the second hollow body. The columns or walls which connect opposite inner walls of the second hollow body may be separate parts which are placed in one part before connection with a second part or may be formed integrally with at least one part. If the columns or walls are formed integrally with one part, they preferably have such a height that the part which forms the opposite inner wall is in contact with the upper end of the columns or walls after being connected to the part with the integrally formed columns or walls. Further, it is also possible to form a part of the columns or walls integrally on those parts which are placed such that they form opposite inner walls of the second hollow body and after connecting the parts of the hollow body, the parts of the walls or columns of the parts of the hollow body which form opposite inner walls also are in contact and such form the columns or walls.

Besides the columns or walls, or additionally to the columns or walls, the inner or outer walls of the second hollow body may be reinforced by ribs or other suitable geometric reinforcements formed on the walls of the parts for producing the second hollow body.

If the insert is made of a foam, a foam must be used which essentially maintains its shape when the polymer melt is fed into the mold. For this purpose, the insert preferably is made of a foam with high compression stiffness.

To further reduce the weight of the plastics component it is further possible, that the insert is a second hollow body which is made of a foam. If such a second hollow body made of a foam would have too little stability, it is possible to fill the hollow body with a lighter material. In case of a polyamide foam for example with a foam made of thermoplastic polyure-thane (TPU), expandable Polyamide (EPA), or polystyrene (PS). By varying the material, stiffness and weight can be adapted to the needs of the plastics component.

If a higher stiffness is needed or the part must have a bigger mass due to noise vibration harshness requirements or if the plastics component has an electric, magnetic or other function which needs a higher weight, the insert may contain a dense and heavy material, for example a non-foamed polymer or a metal.

Suitable materials, the insert may be made of are all materials from which an insert can be formed which essentially maintains its shape when the polymer melt is fed into the mold. Such materials may be for example polymer materials like thermoplastics or thermosets, ce-ramics or metals. Particularly preferably, the insert is made of a polymeric material.

If the insert is made of a polymeric material, preferably a polymeric material is used which forms a homogeneous connection with the polymer being fed into the gap between the insert and the walls of the mold. A homogeneous connection in this context means that the insert and the hollow body enclosing the insert are in contact over the whole surface and particularly that the polymer melt being fed into the gap between the mold and the insert melts the outer surface of the insert and welds to the outer surface of the insert, such that a non-separable form-fit connection between the insert and the hollow body is formed.

Further, to achieve a stable insert, it may be advantageous to reinforce the insert. If a polymeric material is used for producing the insert, the polymeric material may be reinforced by adding short fibers or long fibers or a pulverulent reinforcing material like talc. Further, for reinforcing the insert it is also possible to use continuous fibers. Irrespectively of using short fibers, long fibers or continuous fibers for reinforcing the insert, the fibers may be glass fibers, carbon fibers, aramid fibers, or natural fibers like hemp or wool. If the insert is made of a foam and continuous fibers are used for reinforcing the insert, all known technol-ogies to connect foam and fibers can be used, for example overfoaming the fibers or putting pre-produced fiber parts into/onto the foam which build up the desired load paths.

To be able to recycle the plastics component produced by the inventive process without complex separation steps to separate different materials used for forming the plastics component, it is particularly preferred to use the same polymer for forming the insert and the hollow body.

Suitable polymers for forming the insert and/or the hollow body of the plastics component preferably are a polyamide (PA), polyethylene (PE), polybutylene terephthalate (PBT), poly-esters, polyoxymethylene (POM) or polypropylene (PP). Due to the high compression strength of a polyamide foam, Polyamide based materials, which may be reinforced, are preferred. Thus, if the polymer forming the hollow body e.g. is polypropylene, the insert preferably is made of polypropylene or expanded propylene. If a polyamide is used as polymer for the hollow body, the insert also is made of a polymer and particularly of the same type of polymer as the hollow body.

Besides the insert, it is also possible to use a reinforced polymer for forming the hollow body. In this case, for forming the hollow body, the polymer melt may contain short fibers or long fibers or a pulverulent reinforcing material. The materials, the fibers are made of, or the pulverulent material may be any material known to the skilled person for fibers or as pulverulent reinforcing material and preferably, a material is used as described above in regard to the insert.

Besides a reinforcing material, the polymer material for producing the insert and the polymeric material for producing the hollow body may contain additives as usually used in polymeric materials. Such additives for example are plasticizers, impact modifiers, dyes, or any other type of additive known to the skilled person.

Using a polymer as insert and particularly using a foam or a second hollow body as insert is possible, because under mechanical load usually the highest stresses are located in the outer regions of the hollow body surrounding the insert. For this reason, there are no high stresses acting on the insert and, thus, the insert can be made from a material with lower mechanical performance.

For producing the plastics component, in a first step the insert is placed in a mold. Thereby, the insert is placed into the mold in such a way that a gap is formed between the inner walls of the mold and the insert. This gap defines the cavity for the filling process, by which the hollow body is formed. According to the invention, for forming the gap, elevations are formed on the insert or the mold comprises pins onto which the insert is placed.

If elevations are formed on the insert, the elevations may be formed integrally on the insert or may be separate components which are connected to the insert.

Elevations, which are formed integrally on the insert, preferably are formed while forming the insert. If the insert is made of a foam, the elevations in this case usually also are made of the foam. If the insert is a second hollow body, the elevations in this case are formed on the outer surface of the second hollow body and usually also are formed while forming the parts, the second hollow body is made of. If the parts for forming the second hollow body are made by injection molding, recesses are provided in the molds for producing the parts of the second hollow body at those positions where the elevations should be.

An insert made of a foam may be produced by cutting the insert out of a foam or by forming the foamed insert in a mold. If the foamed insert is formed in a mold, also in this case, recesses are provided at those positions where the elevations shall be. While forming the foamed insert, also the elevations are formed, wherein the elevations also are made of the foam. Also if the insert is cut out of a foamed raw material, the elevations may be formed on the foam or being made of the foam.

If the elevations are separate components, they may be connected to the insert by any suitable method known to the skilled person. The elevations for example may be glued to the insert by using an adhesive or welded to the insert. Further, for connecting the elevations to the insert, they may be partly enclosed from the insert. To enclose the elevations partly from the insert, it is preferred to place the elevations into a mold and subsequently form the insert by injecting either the material forming the foamed insert or by injecting a polymer melt to form the parts for the second hollow body.

Further, if the elevations are separate components, they may be made of a different material or the same material as the insert is made of. However, if the insert and the hollow body which form the plastics component are made of different materials, it is particularly preferred to make the elevations from the same material, the hollow body of the plastics component is made of.

The elevations may have any suitable form, for example a conical or cylindrical shape. Besides a conical or a cylindrical shape any other shape may also be possible. Preferably, the elevations have a conical shape and are connected to the insert or part of the insert in such a way that the tips of the elevations are in contact with the mold when the insert is placed in the mold. Such a conical shape is particularly preferred if the elevations are made of a material different from the polymer the hollow body is made of or are made of a foam. Due to the conical shape and the orientation such that the tips of the conical elevations are in contact with the mold, the surface contact with the mold is minimized and the elevations stay invisible in the plastics part after demolding.

If the elevations are made of a solid material and made of the same polymer as the hollow body of the plastics component, the elevations usually also remain invisible if they have a different shape, for example a cylindrical shape, and a larger contact area with the surface of the mold. Due to using the same material, at least the surface of the elevations melts during feeding the polymer melt and the polymer melt forms an integral connection with the elevations.

For minimizing the contact area with the surface of the mold, it is alternatively also possible to provide the elevations with a convex curved surface on the side facing away from the insert.

However, particularly preferably, the elevations have a conical shape.

If for forming the gap between the inner surface of the mold and the insert the mold comprises pins, the pins may be fixed or retractable. To achieve a closed hollow body enclosing the insert without openings after deforming the plastics component, it is preferred that the pins are retractable. To avoid a displacement of the insert during feeding the mold, it is further preferred, if the pins are consecutively retracted when the polymer reaches them during feeding.

Since the insert remains in the plastics component produced by the inventive process, the insert forms a part of the mold during feeding the polymer melt for forming the hollow body. This has the advantage, that the inner surface of the hollow body may have any possible shape. The insert for example may be furnished with a structured surface.

For forming the structured surface, the insert for example may comprise recesses such that during feeding, the polymer melt fills the recesses. As the insert remains in the plastics component, it is further possible to form protrusions with undercuts on the inner surface of the hollow body of the plastics component.

The structures of the surface may be such that protrusions and recesses are smaller than the average wall thickness of the hollow body. Such structures of the surface may help to define a better load transfer between the stiff polymer material of the hollow body and the insert. Further, a micro treatment, for example small textures or a plasma treatment, of the surface can be advantageous as it enables a better connection of the insert to the hollow body.

Besides the small protrusions and recesses, in a preferred embodiment, the recesses have such a form that the protrusions formed on the inner surface of the hollow body for example form reinforcing ribs. Such protrusions like reinforcing ribs allow to reinforce the hollow body without altering the outer surface of the hollow body. Thus, even though the hollow body has a smooth surface, reinforcing ribs can be provided.

Further, for reinforcing it also may be suitable to form connecting bars which connect opposite inner surfaces of the hollow body. For this purpose, openings are formed in the insert and during feeding the polymer melt, the openings are filled with the polymer melt, thereby forming the connecting bars between the opposite inner surfaces of the hollow body. In this case the design of the core forms defined cavities for the polymer melt. After the filling process those cavities act as well defined load paths in the plastics component which improve the mechanical behavior.

After placing the insert into the mold, the mold is closed and the polymer melt is fed into the mold. For feeding the polymer melt into the mold, any suitable process known to the skilled person can be used. The polymer melt for example may be fed by an injection molding process. In this case, the mold into which the insert is placed before feeding the polymer melt, is a mold of an injection molding machine. Besides feeding the polymer melt by using an injection molding process, a casting process or a centrifugal casting process can be used for feeding the polymer melt into the mold. In these cases the mold is a mold of a casting machine or of a centrifugal casting machine, respectively. However, preferably, an injection molding process is used for feeding the polymer melt into the mold.

For producing long plastics components, particularly long, closed profiles which may be used for example for bending loads or axial crashing scenarios, the polymer melt may be injected into the mold with sequential gating. In this case, the insert is placed in the mold such that the gap between the mold and the insert is formed and subsequently the polymer melt is injected into the mold in a sequential way by opening a first gate through which the polymer melt is injected into the mold, closing the first gate and opening a second gate after a defined amount of polymer melt is injected into the mold and continuing injecting the polymer melt through the second gate. After having injected a defined amount of polymer melt, the second gate is closed and a further gate is opened. This operation is continued until polymer melt has been injected sequentially into the mold through all gates. A good way of controlling the gate opening is to open each gate shortly after their location in the mold has been reached by the melt and simultaneously close the previous gate. With this way of feeding the polymer melt into the mold, the polymer can be injected into the mold with an injection pressure being much lower than necessary in case the polymer melt is injected into the mold via only one injection point. Due to the lower injection pressure also the clamping pressure of the mold can be reduced and it is possible to produce very long profiles without the need for big machines with high clamping pressures and strong injection units.

After feeding the polymer melt into the mold, the polymer solidifies in the mold and subsequently the plastics component is removed from the mold.

Components which may be produced by the inventive process may be any components having thicker regions, in which it is possible to place an insert for decreasing the risk for buildup of internal voids and provide homogeneous wall thicknesses or where hollow parts can be filled with a foamed insert, so that the component can be produced by a less complex process. Further, by using a foam as the insert, it is possible to improve dynamic behavior of the plastics component and thus improve the dynamic responses for a better acoustical and noise vibration harshness behavior.

Plastics components produced with the inventive process for example may be structural parts being used to fix or support other components like e.g. electric motors or combustion engines, support structures for rotating machinery, structural mechanically loaded components, particularly parts which may break due to an impact, for example in vehicles, or components in which other parts are embedded. Such plastics components for example are roof rails, door handles, pedals, chairs, protective undercoating, particularly against highway stone, bicycle frames, seat frames or wheel rims.

Generally, injection molded plastics components which are used as structural mechanically loaded components are made of fiber-reinforced polymers and show complicated geometries, resulting from the high loads and the necessary design.

In many cases it is not possible to place the injection point at the ideal position in the mold for an optimal fill process, i.e. a position at which a balanced fill and an undisturbed fiber-orientation for making use of the anisotropic material behavior and a reduced warpage of the plastics component can be achieved. For an optimal filling of the cavities, an insert is used which comprises a recess which serves as a flow channel and which connects the injection point with the optimal filling point for filling the cavity to improve the quality and the mechanical behavior of the plastics component.

Components being used to fix or support other parts have a dynamic natural frequency behavior which depends on the geometry, the material and the mechanical boundary conditions of the component. If natural frequencies of the components are close to critical frequencies of the main structure, e.g. an electric motor or a combustion engine, this effect leads to undesired resonance effects. If the damping contribution of the component in the resonance frequency ranges is not sufficiently high, the oscillations can lead to a breakage of the part or to undesired airborne noise and bad acoustic behavior.

Overmolding a foam as an insert allows new designs for plastics components such that resonance behavior as well as damping behavior can be actively controlled by the material, the geometry and the placement of the foam insert. Tis approach of overmolding an adapted foam insert allows an intelligent modification of the dynamic behavior to actively control and improve the dynamic responses in the system.

Enclosing the insert made of a foam with the polymer as the advantage that the injection molded polymer is placed to the outer skin of the available space. Here the loads are transferred much more efficient. There is no need to design complex geometries of moving metal tool sections or trading in some performance due to the necessary demolding direction in injection molding.

This effect becomes obvious when torsional loads have to be transferred. A closed cross section in torsion is always advantageous compared to an open section. Open sections generally have to be used in standard injection molding due to demolding. Closed sections can easily be used when designing components having an overmolded foam insert.

Plastics components which define the visible outer skin of an assembly may have requirements regarding crash, impact scenarios or misuse. Drop tests of consumer machines are an example for such requirements

Depending on the material chosen for the cover, a crash scenario may result in a brittle failure of the outside skin, where debris is created by the crushing nature of the failure. Many manll failed particles may lead to an undesired behavior as they disassemble and penetrate the environment.

By using an insert, the failure type can be changed. On the one hand, a foamed insert dis-tributes the energy more homogeneously in the component and thus reduces local stresses. On the other hand, the tight connection being established between the foamed insert and the polymer melt can prevent the part from disassembling into many small particles.

If the plastics component needs to be connected with other parts and/or other parts have to be incorporated in injection molded components, the additional parts may be incorporated by including them into the insert before or after overmolding. The parts may be incorporated by any known connection technique, for example gluing, screwing, snapping etc. Parts to be incorporated into the plastics components are for example sensors, electrical devices, elec-tronic circuit boards, metal reinforcements, inserts with and/or without threads.

For incorporating the additional part, the insert may contain a cavity into which the part to be incorporated in the plastics component is placed. After putting the additional part into the cavity, the opening in the foam may be closed and then overmolded by the polymer melt. The additional part in this case is safe and secure in the insert and will not been dam-aged by the polymer melt.

Possible connections of the additional part to the outside, e.g. electrical cables also may be incorporated by a defined border of the foamed insert with the polymer melt.

If additional parts have to be incorporated into the plastics component which are rather soft and not able to withstand the filling pressure of the polymer melt during the injection molding process without notable deformations, these additional parts can be incorporated into the foamed insert and fixed relatively to each other so that no relative deformation during injection molding process occurs. Such soft additional parts for example may be wires and rods used as electrical conductors. Deformation during the injection process so that they touch each other may result in electrical short circuits. In this case the component does not work and is useless. If the additional parts are used as mechanical structures, a deformation would mean that the desired mechanical function is at least weakened or even de-stroyed. By incorporating the additional parts into the insert of the plastics component, the component still has the same outer shape, but the core shift tendency during the filling process is minimized.

For incorporating the additional parts into the foam, the additional parts may be put into a foam tool before starting the foaming process and thereby embedding them into the foam insert. Alternatively, the foamed insert may be produced separately and the additional parts may be incorporated into the foamed insert after the foaming process.

Embodiments of the invention are shown in the figures and are described in more detail in the following description.

In the figures:

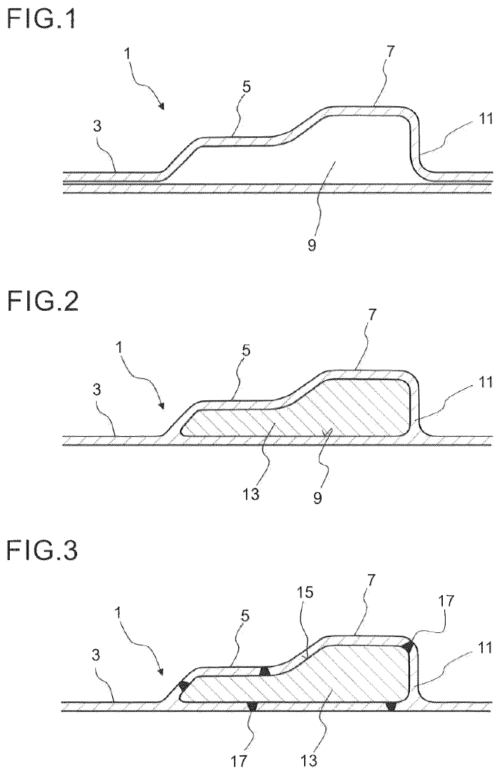

FIG. 1 shows a plastics component produced by a GAIM/WIT process according to the state of the art;

FIG. 2 shows a plastics component produced by the inventive process;

FIG. 3 shows a plastics component with elevations on the insert having a conical shape;

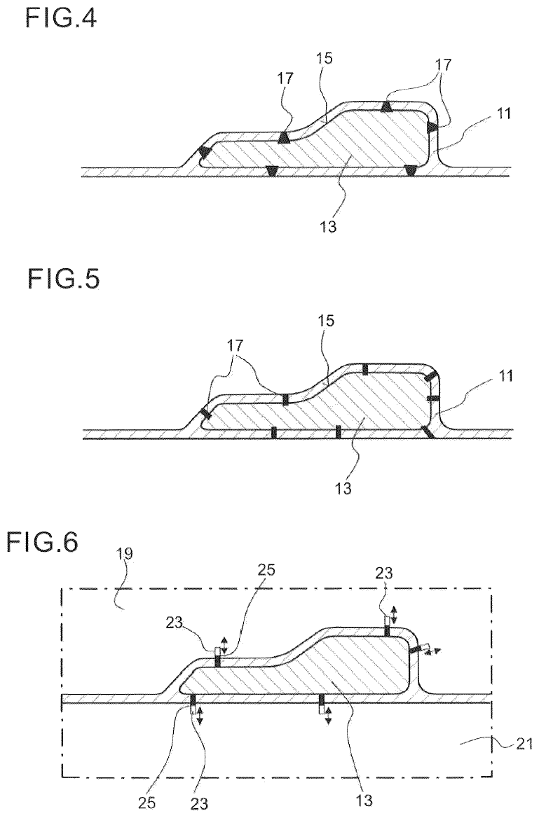

FIG. 4 shows a plastics component with elevations on the insert having a conical shape in a second embodiment;

FIG. 5 shows a plastics component with elevations on the insert in the form of cylindrical pins;

FIG. 6 shows schematically a fixation of the insert with retractable pins;

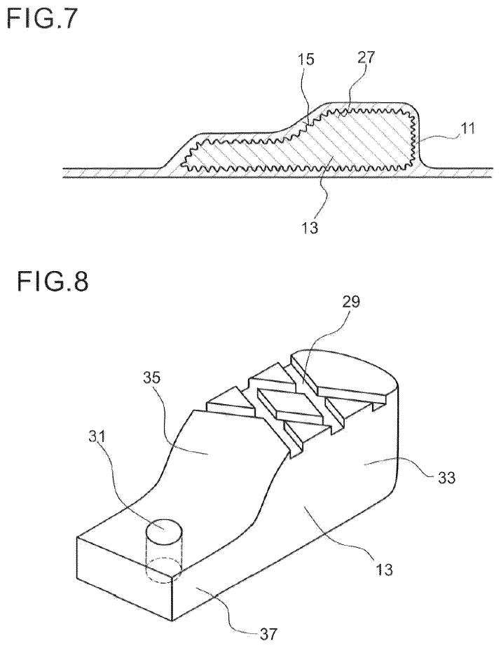

FIG. 7 shows a plastics component with an insert having a structured surface;

FIG. 8 shows an insert with recesses and an opening to form additional cavities to be filled;

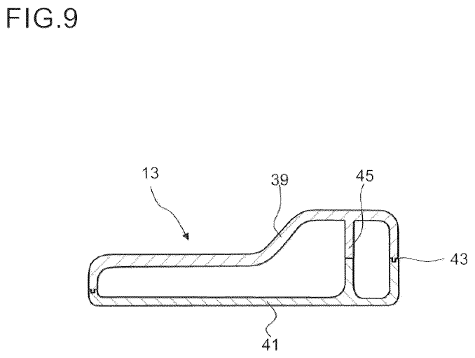

FIG. 9 shows an insert in the form of a hollow body;

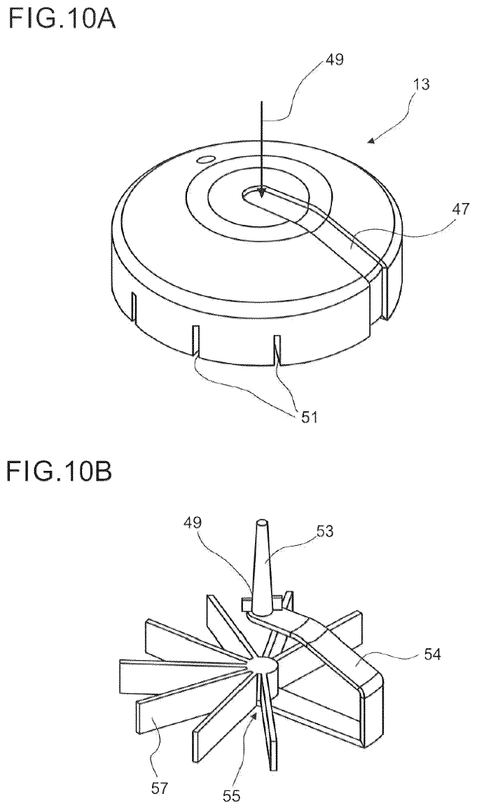

FIG. 10a shows an insert with a recess as flow channel;

FIG. 10b shows the plastics part injected into the insert of FIG. 10a;

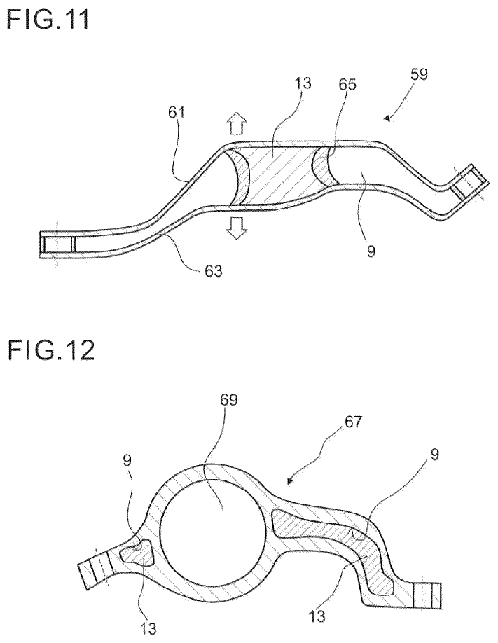

FIG. 11 shows a bracket with foamed insert for improving the noise vibration harshness;

FIG. 12 shows an engine mount for an electric engine;

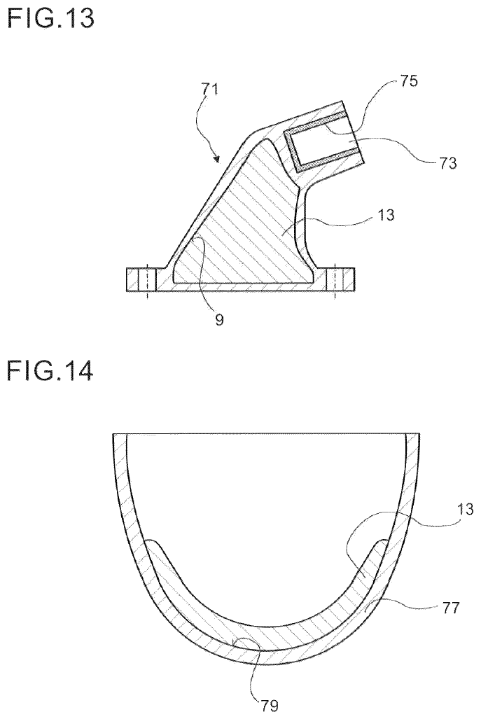

FIG. 13 shows an engine mount for a combustion engine;

FIG. 14 shows a plastics component with a foamed insert for avoiding disassembly in a crash scenario;

FIG. 15 shows a plastics component with an insert with a cavity for incorporating an additional part;

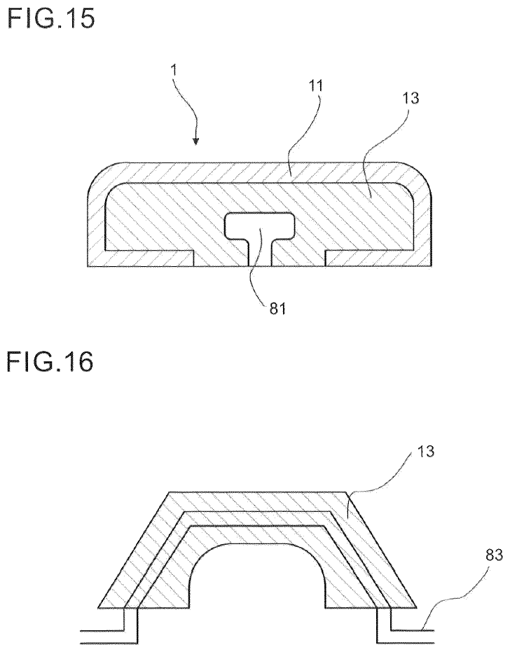

FIG. 16 shows an insert with incorporated soft parts; and

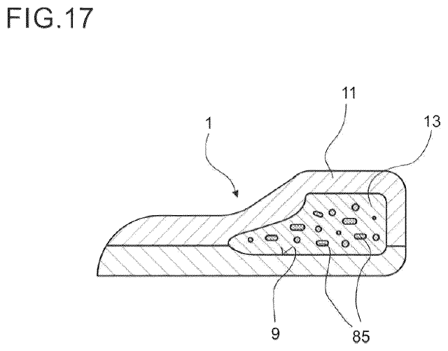

FIG. 17 shows a plastics component with an insert with incorporated different material.

In the figures an exemplary plastics component is shown for demonstration purposes. A plastics component produced by the inventive process may have any geometry which can be produced by an injection molding or casting process and may have for example more or less sections having different wall thicknesses as shown here. Plastics components produced with the inventive process for example may have a simple geometry like a cylinder, a cone, or a sphere or may have any other geometric shape. Further, the plastics component may have a much more complex structure as shown here.

FIG. 1 shows an exemplary plastics component produced by a GAIM/WIT process according to the state of the art.

A plastics component 1 comprises several sections having different thicknesses. A first section 3 with a small wall thickness, a second section 5 with a medium wall thickness and a third section 7 with a large wall thickness. To avoid material accumulations in the second section 5 and the third section 7, the plastics component comprises a cavity 9, which is enclosed by the polymer material, which forms a hollow body 11.

According to the state of the art, the cavity 9 is formed by injecting a gas or a liquid after having filled a mold with a polymer melt. The gas or the liquid cast out polymer melt and the cavity 9 forms. By this process material accumulations are avoided and the hollow body 11 is produced.

However, due to the process, variations in wall thickness of the hollow body and uneven walls cannot be avoided. Further slight variations in pressure or velocity of the gas or liquid for removing the polymer melt may result in differences of the geometry of the hollow body.

To avoid these disadvantages, by the inventive process a plastics component is produced which comprises an insert which is enclosed by a hollow body. An example for such a plastics component is shown in FIG. 2.

The plastics component 1 of FIG. 2 has the same exterior geometry as the plastics component 1 shown in FIG. 1. However, in difference to the plastics component 1 produced by a process according to the state of the art, the plastics component 1 produced by the inventive process comprises an insert 13 which completely fills the cavity 9 of the hollow body 11.

By using the insert 13, it is possible to produce the hollow body 11 with defined wall thicknesses and to avoid unintended different wall thicknesses. The insert 13 may be for example a foam or a second hollow body which may be made of a metal, a ceramic or an option-ally reinforced polymer.

For producing the plastics component 1, the insert 13 is placed in a mold, thereby forming a gap between the insert 13 and the inner walls of the mold. Afterwards, a polymer melt is fed into the gap, forming the hollow body 11.

For forming the gap, it is possible to either provide elevations on the insert or use pins in the mold onto which the insert is placed.

FIGS. 3 to 5 show different embodiments for elevations on the insert.

A plastics component with elevations having a conical shape on the insert is shown in FIG. 3.

to achieve a hollow body 11 having a desired wall thickness, it is necessary to provide a mold into which the polymer melt is fed, which has a cavity corresponding to the desired shape of the hollow body. According to the inventive process, the cavity is bounded by the inner walls of the mold and the surface 15 of the insert 13. As the surface 15 of the insert is opposite the inner walls of the mold, the cavity into which the polymer melt for forming the hollow body 11 flows, has the form of a gap. The distance between the surface 15 of the insert 13 and the inner walls of the mold and, thus, the thickness of the walls of the hollow body 11 is defined by elevations 17 on the insert 13.

When the insert is placed into the mold, the elevations 17 are in contact with the inner walls of the mold and the insert 13 rests with the elevations 17 on the inner walls of the mold. By this, the gap is formed into which the polymer melt for forming the hollow body 11 flows.

In the embodiment shown in FIG. 3, the elevations are placed on top of the surface 15 of the insert 13. This can be achieved by providing elevations and connect them to the surface of the insert, for example by gluing or welding. In this case, the elevations 17 may be made of the same material as the insert 13 or of a different material which can be fixed to the surface 15 of the insert 13. If the insert 13 and the hollow body 11 are made of different materials and the elevations are made of a material different from the material the insert is made of, it is particularly preferred if the elevations 17 are made of the same material as the hollow body 11. If the insert 13 and the hollow body 11 are made of the same material, it is preferred that the elevations 17 also are made of the same material.

Besides producing the elevations 17 separately from the insert 13 and fix them on the surface 15 of the insert 13, it is also possible and preferred to produce the elevations 17 integrally with the insert 13.

Particularly if the elevations 13 and the hollow body 11 are made of different materials or the elevations 17 are made integrally with the insert 13, a conical shape of the elevations 17 as shown in FIG. 3 is preferred to minimize the contact area of the elevations 17 on the inner walls of the mold. This is particularly preferred, if the elevations 17 are produced integrally with the insert 13 and the insert is a foam, because in this case, the elevations 17 also are made of the foam.

An alternative for fixing elevations 17 to the insert 13 is shown in FIG. 4.

The elevations shown in FIG. 4 also have a conical shape. However, in difference to the embodiment shown in FIG. 3, the elevations 17 shown in FIG. 4 are not fixed on the surface 15 of the insert 13 but are partly enclosed from the material of the insert 13. This design of the insert 13 has the advantage that for fixing the elevations 17 to the insert 13 no adhesive for gluing or additional step for fixing them onto the surface 15 of the insert 13, for example by welding, is needed.

Such a design of the insert 13 with partly enclosed elevations 17 is particularly preferred if the elevations 17 are made of a solid material and the insert 13 is made of a foam. Also in this case, the elevations 17 preferably are made of the same material as the hollow body 11.

For producing the insert 13 with partially enclosed elevations 17, for example the elevations 17 are placed in a mold for producing the insert 13 and subsequently the material for forming the insert 13 is fed into the mold.

A further alterative for elevations 17 being at least partly enclosed from the material of the insert 13 is shown in FIG. 5.

The embodiment shown in FIG. 5 differs from that shown in FIG. 4 only in the shape of the elevations 17. In difference to the embodiment of FIG. 4, the elevations 17 of the embodiment shown in FIG. 5 have a cylindrical shape.

Besides the cylindrical shape of the elevations 17 shown in FIG. 5 or the conical shape of the elevations 17 shown in FIG. 3 or 4, the elevations 17 may have any other shape, for example a pyramid, a sphere or a hemisphere, or a cube.

Alternatively to the elevations 17 for forming the gap into which the polymer melt for forming the hollow body 11 flows, as shown in FIGS. 3 to 5, for forming the gap pins in the mold may be used. This is exemplary shown in FIG. 6.

For illustrative purposes, FIG. 6 shows a section of a mold, the mold comprising a first part 19 and a second part 21. For molding the hollow body 11 of the plastics component 1, the first part 19 and the second part 21 are closed, thereby forming the mold. Each part 19, 21 of the mold comprises openings 23 in which pins 25 are accommodated. The pins 25 either may be fixed or, preferably, retractable. If the pins are retractable, for placing the insert 13 into the mold, the mold is opened and the pins 25 are moved into a first position protruding into the mold. The length with which the pins protrude into the mold corresponds to the width of the gap, into which the polymer melt is injected for forming the hollow body. Afterwards, the insert 13 is placed on the pins and the mold is closed. Alternatively, it is also possible to place the insert on the inner surface of the first part 19 or the second part 21, close the mold and then move the pins 25 into the protruded position for forming the gap.

For forming the hollow body, it is possible to leave the pins 25 in the protruded position during feeding the polymer melt. However, this has the disadvantage that the hollow body has holes after removing from the mold. Therefore, it is preferred to use retractable pins 25 and consecutively retract the pins 25 into their openings 23 when the polymer melt reaches the respective pins 25 during filling the mold. By consecutively retracting the pins 25 during filling the gap, the gap upstream the melt front is filled with polymer melt and thus, the insert 13 remains at its place.

FIG. 7 shows a plastics component with an insert having a structured surface.

Besides a smooth surface as shown in FIGS. 2 to 6, the surface 15 of the insert 13 may have a structure 27. Depending on the intended function of the structure 27, the insert 13 may have a structure 27 with small surface variation or with large surface variation. A small surface variation means that the distance between the highest point of protrusions and the lowest point of recesses of the structure is smaller than half the average wall thickness of the hollow body. A small surface variation for example can help to define a better load transfer between the material of the hollow body 11 and the material of the insert 13. Further, particularly when a torsional load acts on the plastics component, a small surface variation better connects the insert 13 to the hollow body 11 and, thus, the insert 13 does not slip inside the hollow body 11 but also distorts when a torsional load acts on the plastics component and the relative position of the contact surfaces of the insert 13 and the hollow body 11 remains constant.

The structure 27 may have any suitable geometry, for example undulated, zigzag, triangular or grooved. Further, the surface may have elevations in any possible shape, for example pyramids, cones, hemispheres, cylinders or with any other shape.

Besides a small surface variation, the structure also may comprise a large surface variation which means that the distance between the lowest point of the recesses and the highest point of protrusions is larger than half the average wall thickness or the hollow body. Such large surface variations may comprise for example reinforcing ribs. Besides a structure with either small surface variation or large surface variation, also a combination of small surface variation and large surface variation is possible.

An example for an insert having a structure with large surface variation is shown in FIG. 8.

The insert 13 comprises recesses 29 and a hole 31. When filling the gap with the polymer melt for forming the hollow body, polymer melt flows into the recesses 29 and the hole 31. After curing, the polymer which filled the recesses 29 forms ribs on the inner surface of the hollow body. The polymer which filled the hole 31 forms a connection between two opposite inner surfaces of the hollow body, thereby reinforcing the polymer component.

Besides comprising recesses 29 and a hole 31 as shown here, the insert 13 also may comprise only at least one hole 31 or only recesses 29 for forming reinforcing ribs on the inner surface of the hollow body 11. The geometry of the recesses thereby depends on the intended form of the reinforcing ribs. Besides intersecting grooves as recesses 29 as shown here, the recesses 29 also may be grooves with any shape arranged in parallel. Further, it is possible to provide the recesses 29 not only on the thickest part 33 of the insert 13 as shown here but also on further surfaces, like the inclining surface 35 connecting the thinner part 37 with the thickest part 33 and/or on the thinner part 37. Further, grooves 29 may be provided on any other surface of the insert 13.

The optimal position and shape of the recesses depends on the intended shape of the reinforcing ribs for optimal mechanical performance and can be determined by a simulation cal-culation. The same also applies for holes 31 through which the polymer melt flows for forming connections between two inner surfaces of the hollow body.

The hole 31 may have any cross sectional area, for example circular as shown here. However, besides a circular shape, the cross sectional area may be for example oval, quadratic, triangular, cross-shaped or have the form of any polygon. Further, the cross sectional area of the hole may be constant over the whole length of the hole 31 or vary. The cross sectional area for example may decrease or increase or firstly decrease and then increase or firstly increase and then decrease. Further, the hole 31 may change the shape of the cross sectional area along its length.

The insert 13 as shown in FIGS. 2 to 8 preferably is made of a foam. As an alternative, the insert 13 also may be a second hollow body. This is shown for example in FIG. 9.

If the insert 13 is a second hollow body, it is preferred that the insert 13 comprises at least a first part 39 and a second part 41, wherein the first part 39 and the second part 41 are connected and thereby form the insert 13. However, besides only two parts 39, 41 as shown here, depending on the shape of the insert 13, the insert 13 also may be made of more than only two parts.

For a stable connection of the parts 39, 41 forming the insert, it is preferred if the connecting edges 43 of the parts 39, 41 are structured, for example as shown here by having a tongue and groove. When connecting the parts, the tongue slips into the groove and, thus, the parts cannot move against each other. As an alternative to tongue and groove as shown here, it is also possible to provide each of the connecting edges with a protrusion, the protrusion of one part on the outer surface and the protrusion of the other part on the inner surface, so that the part with the protrusion on the inner surface can slip into the part with the protrusion on the outer surface and thus form a stable connection.

Additionally, the parts may be fixed for example by gluing or welding.

For reinforcing the insert 13, which forms a second hollow body, it is possible to provide columns or walls 45 by which two opposite inner surfaces of the hollow body are connected. Thereby, the columns and/or walls may be produced on one part of the insert 13 or partly on two parts, wherein the contacting parts of the partly formed columns and/or walls form the connecting column or wall inside the second hollow body, as shown here.

As an alternative or additionally to a wall or column connecting two opposite sides there also may be formed reinforcing ribs on a part of the inner surface or on the whole inner surface of the second hollow body.

FIG. 10a shows an example for an insert 13 with a recess 47 as flow channel. The recess 47 connects an injection point 49 at which the polymer melt is injected into the mold with a distribution point for distributing the polymer melt into cavities 51 in the insert 13. The injection point 49 is at a position in the mold where it can be easily positioned and the distributing point for distributing the polymer melt is at a position which allows for an optimal filling of the cavities 51, i.e. a balanced fill, a reduced warpage of the plastics component 1 and, if the polymer melt contains fibers, an undisturbed fiber orientation for achieving an anisotropic material behavior. Further, by placing the injection point where it can be easily positioned and the distribution point at a position for an optimal filling of the cavities, an improved quality and mechanical behavior of the resulting plastics component is achieved.

A plastics part after injecting the polymer melt into the cavities of the insert 13 of FIG. 10a is shown in FIG. 10b. The plastics part comprises a sprue 53 at the injection point 49, a bar 54 which is formed in the flow channel and which connects the injection point 49 and the distribution point 55, and ribs 57 which are formed in the cavities 51 of the insert.

FIG. 11 shows schematically a bracket with foamed insert for improving the noise vibration harshness.

A bracket 59 which has improved noise vibration harshness may comprise a first bracket part 61 and a second bracket part 63. The insert 13 is placed between the first bracket part 59 and the second bracket part 61 and may additionally be enclosed by connecting parts 65 which connect the first and second bracket parts 61, 63. Due to its position, geometry and material, the insert 13 effectively changes the dynamic behavior of the bracket 59 and, thus, improves the dynamic responses for a better acoustical and noise vibration harshness behavior.

The insert 13 may fill the cavity 9 between the first bracket part 61 and the second bracket part 63 fully or partly. If the insert 13 fills the cavity 9 only partly, it is for example possible that during injecting the polymer melt for the first and second bracket parts 61, 63 the insert 13 is positioned into the mold by elevations on the insert 13 or pins in the mold and the parts which remain hollow are filled with respective parts of the mold.

Depending on the oscillations, it may be advantageous to use and position the insert 13 in different directions according to the given main loads in shear, tension and/or compression. The insert 13 itself, which preferably is made of a polymer foam, may be the main component where energy is dissipated or operates as a modifier or enabler so that the rest of the whole plastics component behaves in a desired way.

Examples for plastics components with an improved noise vibration harshness which can be produced with the inventive process for example are engine mounts for electric engines or for combustion engines as shown exemplary in FIGS. 12 and 13.

An engine mount 67 for electric engines comprise a space for accommodating an electric motor. For damping vibrations, the engine mount 67 has cavities 9, which are filled with inserts 13 made of a foam. The cavities 9 filled with the insert 13 have the additional advantage that it is possible to design the engine mount 67 with essentially constant wall thicknesses. Further, the massive plastic parts form the outer skin of the engine bracket 67 and thus load are transferred much more efficient. There is no need to design complex geometries of moving metal tool sections or trading in some performance due to the necessary demolding direction in injection molding.

This effect becomes obvious when torsional loads have to be transferred. A closed cross section in torsion is always advantageous compared to an open section. Open sections nor-mally have to be used in standard injection molding due to demolding. Closed sections can easily be used when designing parts using the inventive production process for overmolding an insert.

An engine mount 71 for a combustion engine as shown exemplary in FIG. 13 comprises a cavity 9 which is filled with an insert 13 and which damps vibrations of the combustion engine. Further, for mounting the combustion engine, the engine mount 71 comprises a blind hole 73 which incorporates a metal insert 75 for accommodating fixation elements of the combustion engine.

The inventive process further allows to produce plastics components with a foamed insert for avoiding disassembly in a crash scenario. An example for such a plastics component is shown in FIG. 14 in a cross sectional view.

A component which does not disassemble in a crash scenario and where the number of small particles being penetrated into the environment after crash is reduced, comprises an outer part 77 which generally forms an outer wall and may be the visible part of the component, for example the outer skin of a bumper. The insert is fixed on an inner surface 79 of the outer part 77 and, thus, not visible after installation. The tight connection of the insert 13 and the outer part 77 holds the parts together in case of an impact or crash. Further, the insert 13, particularly when made of a foam, strengthens the outer part 77 in bending so that the overall strength is increased.

Using the insert 13 which is enclosed by a hollow body 11 has the additional advantage that additional parts may be incorporated into the plastics component 1. For this purpose a cavity 81 is formed in the insert 13 as shown in FIG. 16.

The additional part which is not shown here, is placed in the cavity 81 of the insert 13. Depending on the shape of the part to be incorporated in the insert 13 and, thus, the shape of the cavity 81, it may be necessary to use an insert being made of several pieces, which are assembled before the insert 13 made of the several pieces is placed in the mold for being overmolded with the polymer melt.

Parts to be incorporated into the cavity 81 for example are sensors, electrical devices, elec-tronic circuit boards, metal reinforcements, inserts with or without threads or any other part known to a skilled person that may be incorporated into a plastics component 1.

If the additional parts are soft and may be deformed during an injection molding process, for example wires or rods used as electrical conductors, the insert 13 can be used to fix the additional parts. An example for an insert 13 with conductors 83 as incorporated soft parts is shown in FIG. 16.

The soft additional parts, for example the conductors 83 may be embedded into the foam of the insert by putting them into a tool for producing the foamed insert before filling the components which form the foam into the tool. On the other hand it is also possible to firstly form the insert from the foam and subsequently put the soft inserts into the foam after the foaming process.

After finishing the insert with the additional parts, the insert 13 is placed into the mold and the polymer melt is injected into the gap between the insert 13 and the inner walls of the mold.

Besides using a hollow insert 13 it is also possible for reducing the weight of the plastics component 1 to fill the cavity in the insert 13 with a lighter material, for example with a foam having a lower density.

On the other hand, if a higher mass of the plastics component 1 is necessary, for example to provide higher stiffness, for improving the noise vibration harshness or if the plastics component 1 shall have an electric, magnetic or other function, a dense and heavier material may be incorporated into the insert 13. The material incorporated into the insert 13 depends on the intended function and may be for example an electrical conductive or a magnetic material, for example a metal. Further, for increasing stability or weight, also a polymer having a higher density than the material of the foam of the insert may be incorporated into the insert 13, for example on non-foamed polymer.

An example of a plastics component 1 with an insert 13 with additional different material 85 is shown in FIG. 17.

1.-15. (canceled)

16. A process for producing a plastics component comprising an insert which is enclosed by a hollow body, the process comprising:
(a) placing the insert into a mold such that a gap is formed between the insert and the mold;
(b) feeding a polymer melt into the gap thereby forming the hollow body enclosing the insert;
(c) removing the plastics component from the mold;
wherein for forming the gap elevations are formed on the insert, or wherein the mold comprises pins on which the insert is placed, or wherein the gap is a recess in the insert.

17. The process according to claim 16, wherein the insert is made of a foam or is a second hollow body.

18. The process according to claim 17, wherein the second hollow body comprises columns or walls connecting opposite inner walls of the second hollow body for reinforcing the second hollow body.

19. The process according to claim 16, wherein the insert is made of a metal, a ceramic or a polymer.

20. The process according to claim 16, wherein the insert is made of a polymeric material which forms a homogeneous connection with the polymer being fed into the gap.

21. The process according to claim 16, wherein the polymer the insertis made of and the polymer the hollow body is made of is a polyamide, polyethylene or polypropylene.

22. The process according to claim 16, wherein the polymer which is inserted into the gap is the same polymer the insert is made of.

23. The process according to claim 16, wherein the elevations are made from the same material as the insert.

24. The process according to claim 16, wherein the elevations are formed integrally on the insert.

25. The process according to claim 16, wherein the elevations are separate components and connected to the insert.

26. The process according to claim 16, wherein the elevations have a conical shape and the elevations being connected to the insert in such a way that the tips of the elevations are in contact with the mold when the insert is placed in the mold.

27. The process according to claim 16, wherein the pins of the mold are retractable, and the pins are consecutively retracted when the polymer melt reaches them during feeding the polymer melt.

28. The process according to claim 16, wherein the insert has a structured surface.

29. The process according to claim 16, wherein the surface of the insert comprises recesses such that during feeding the polymer melt, the polymer melt fills the recesses, the recesses having such a form that reinforcing ribs are formed on the inner surface of the hollow body.

30. The process according to claim 16, wherein openings are formed in the insert which are filled with the polymer melt during the feeding step, thereby forming connecting bars between tow opposite inner surfaces of the hollow body.
